(19) United States
(12) Patent Application Publication
(10) Pub. No.: US 2004/0066648 A1
(43) Pub. Date: Apr. 8, 2004

(54) Lighting system with inflatable structure

(76) Inventor: Marco Tambini, Massa (IT)

Correspondence Address: HARRISON & EGBERT, 412 MAIN STREET, 7TH FLOOR, HOUSTON, TX, 77002, US

(21) Appl. No.: 10/467,227

(22) PCT Filed: Feb. 4, 2002
(86) PCT No.: PCT/IT02/00063

(30) Foreign Application Priority Data
Feb. 7, 2001 (IT) MS01A00002

(51) Int. Cl. F21V 33/00

(52) U.S. Cl. 362/101; 362/96

(57) ABSTRACT

The invention is a new lighting system constituted by a bearing structure (S) that can be inflated manually, with the mouth or electrically with fans, made of fabric or plastic material and provided with one or more light sources (L) at its top and with a support base (B) to its bottom. This bearing structure (S) comprises an airtight air tube provided with a suitable valve system (VG, VS, VR) for the inlet, maintenance and outlet of air and with a manual or automatic system that operates the fans and opens the air inlet valves (VG, VR) to keep a constant pressure inside the structure (S). The pressure can be measured by a set of sensors (PS, PI) connected to a logic circuit that gives or denies consent for the operation of the fans and of the valve. The bearing structure (S) can be produced by combining two surfaces, an inner one suitable for ensuring airtightness and an outer one suitable for ensuring mechanical resistance. The operation of the fans and the valves can be controlled by a timer instead of a logic circuit

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention concerns the sector of lighting systems and in particular it concerns lighting systems provided with lamps, whose bearing structure, which supports the light source at a given height, is made of fabric and is operative thanks to an inflation system where pressurized air is constantly blown into the structure by means of fans or compressors.

### BACKGROUND OF THE INVENTION

Patent No. WO 99/47853 (MEDICI G.) is known, which concerns emergency lights. In the mentioned lights the bearing structure is constituted by a cylinder, or other elements with similar shape, whose shape is maintained owing to the pressure created inside it. The structure obtained in this way is capable of lifting a light source at the desired height, with no need to use metal structures (telescopic tubes, poles or reticulated structures).

The advantages offered by this system are its reduced weight and dimensions and the possibility to position the light source at considerable heights by modifying the pressure and giving the correct shape to the bearing structure, since in this way it is possible to light very wide areas.

Compared to traditional systems (usually constituted by lamps positioned on poles, reticulated structures or improvised supports), however, the system with bearing structures inflated by constantly blowing air into them has the drawback that it is very noisy, due to the operation of the fans or compressors.

In fact in some specific cases, for example in the case of restaurants, campsites, outdoor events, it is necessary to use noiseless systems, in order not to cause disturbance.

Usually, when forced ventilation systems are used, noise is generated by both the air flow and the mechanical movement of the components comprising the driving unit (motors, fans, etc.). Noise can be reduced through the application of silencing systems, like deadening surfaces, sound “traps”, partitions.

### BRIEF SUMMARY OF THE INVENTION

Compared to these systems, which limit but don't eliminate the problem, the invention represents an original solution, since:

a) the bearing structure is airtight;

b) the inflation of said structure can be carried out mechanically, manually, by blowing with the mouth or using suitable fans;

c) the operation of any fans and noisy equipment used to maintain the internal pressure and therefore the stability of the structure is confined to the time required for the inflation; and

d) it is possible to provide the bearing structure with an automatic system to check the internal pressure.

The components of the lighting system are the following:

1. ground support base comprising a container that acts as a ballast and/or as a container for the electrical and mechanical components necessary for the operation of the system;

2. cylindrical or conical bearing structure for the light source; and

3. light source.

### BRIEF DESCRIPTION OF THE SEVERAL VIEWS OF THE DRAWINGS

FIG. 1

FIG. 2

### DETAILED DESCRIPTION OF THE INVENTION

The components of the lighting system are the following:

1. ground support base comprising a container that acts as a ballast and/or as a container for the electrical and mechanical components necessary for the operation of the system;

2. cylindrical or conical bearing structure for the light source; and

3. light source.

The bearing structure can be inflated in the following ways:

a) manually, by means of a simple pump;

b) by blowing air into the structure with the mouth; and

c) electrically, by operating suitable fans and/or compressors housed in the base.

The inflation of the bearing structure carried out as described above allows the bearing structure to extend upwards, thus bringing the light source, if this is placed on its top, at the ideal height for the optimization of the lighting effect.

The inflation of air, be it carried out manually or with the mouth, is possible owing to the presence of special valves positioned on the outer wall of the bearing structure. If the air is blown in electrically by means of fans or compressors positioned inside the base, it is necessary to install non-return valves or mechanisms on the air inlet. For this purpose, the system can be equipped with a solenoid valve or a unidirectional diaphragm valve or, alternatively, the lifting and lowering movements of the lower wall of the cylinder due to the action of the fans may be exploited. In fact, if a hole with proper diameter is made on the lower section of the cylinder, when the air is forcedly blown in, that part of the cylinder lifts from its support plane and the air is free to get into the cylinder. When the operation of the fans is interrupted, the same section lowers immediately due to the pressure difference between the inside and the outside of the cylinder. Due to the lowering movement, the air inlet hole automatically rests on the base surface, thus ensuring airtightness. To obtain perfect tightness, it is possible to make the support base with a suitable curve (spherical cross section) and to surround the hole of the cylinder base circular cross section with suitable O-rings.

Independently of the system used, when the valve is closed the operation of the fan is interrupted and vice versa.

To guarantee that the pressure inside the bearing structure does not drop, the walls of the bearing structure itself must be airtight.

In the systems in which a constant air flow is used to maintain the inside pressure, the bearing structure is generally made of acrylic fabric with a given porosity. The air escape due to such porosity justifies and makes necessary the constant supply of air and pressure to the inside of the structure.

In our case the bearing structure comprises an airtight inner air tube made of heat-sealed plastic material and an external fabric having mechanical characteristics suitable for ensuring the soundness of the air tube and maintaining the desired shape of the bearing structure, at the same time limiting the elasticity of the internal air tube and its possible deformations due to pressure. Said fabric can be made of natural fibers, like cotton, or acrylic fibers, like Dacron and its derivatives.

It is also possible to combine different materials having the necessary airtightness and appropriate mechanical characteristics.

The light source can be positioned inside or outside the bearing structure, at its top or at its base.

The bearing structure is fixed to the base, where the air inlets are obtained. The operating mechanism is the following:

1. upon setting the system at work, the operator provides for inflating the bearing structure either manually, or with his mouth, or electrically, by means of a special switch. When the structure has been inflated, the operator releases the switch, thus interrupting the air flow into the bearing structure, and the valve closes; and

2. in particular, in bearing structures characterized by considerable dimensions, and considering that pressure drops due to the imperfect tightness of the air tube cannot be excluded, it may be necessary that the fans automatically start working again when the pressure falls below the minimum value required to allow the bearing structure to act as a support. This automatic operation can be obtained in three ways, depending on the uses for which the lamp is meant:

a) according to the setting defined during the design phase;

b) according to time intervals to be decided by the user; or

c) automatically, in case of pressure drops below a given value.

The automatic operation as per point 2a is obtained thanks to the coordinated and pre-defined action of preset timers.

The timers start working, operate the fans, open the valve and determine how long air must be blown into the bearing structure to reach the pressure value necessary for its stability.

The automatic operation as per point 2b requires the installation of a coordinated system of timers that can be set directly by the user.

The automatic operation as per point 2c requires the installation inside the bearing structure of electronic pressure sensors, with the aim to regulate the air flow into the bearing structure or to automatically interrupt said flow. In this case, the operation of the system is guaranteed by the installation of a logic circuit ensuring the correct working of the two sensors.

Instead of the solenoid valve, also a unidirectional diaphragm valve can be used to close the air outlets, the opening or closing of said unidirectional diaphragm valve being determined by the start or stop of the air flow generated by the fans.

According to a third system, a central hole with suitable diameter is provided on the lower section of the bearing structure and on the support base there is a support plane against which the hole rests in static conditions.

When air is blown into the bearing structure, the fans lift the base section of the structure from the support plane, thus freeing the hole through which the air passes into the bearing structure. Once the fans have stopped, the internal pressure present inside the bearing structure pushes the base section downwards and the hole rests on the support plane, which ensures the required tightness.

The light source is constituted by high or low-voltage incandescent lamps or discharge lamps. These sources can be positioned inside or outside the bearing structure, at its top or at its base.

The position of the light source on top of the bearing structure offers obvious advantages, since light propagates with the maximum efficiency. However, it may be necessary to position the light source at the base of the bearing structure. When the light source is positioned at the base of the bearing structure, the light beam must be projected towards the top and concentrated on a reflecting surface, so that light is properly propagated towards the outside. The reflecting surface at the top makes it possible to optimize light propagation, with lighting effects that are similar to those obtained when the light source is positioned on top of the bearing structure. To optimize these effects, it is necessary to concentrate the light beam as much as possible on the reflecting surface positioned on top of the bearing structure. In this case, the concentrated projection of the light beam on the top of the bearing structure is obtained by means of parabolic surfaces and/or lenses positioned near the light source.

However, there may be the problem of spreading light even inside the bearing structure, if also this structure must be lit. In this case, the diffusion of light inside the bearing structure is achieved through the application of a plate in transparent material on top of the structure. If the light source is positioned at the base of the bearing structure, the transparent plate will be placed at the base of the bearing structure, with reflecting surfaces on its top.

To increase the effect of light diffusion on the walls of the bearing structure, at the same time guaranteeing uniform lighting, it is possible to apply on the inner surfaces of the bearing structure substances capable of properly reflecting the light beam. The fans and the light source can be powered with high or low voltage.

Considering that, for safety reasons, for the use of an external lighting system it is preferable to choose a low-voltage power supply, some problems may arise, due to the fact that low-voltage motors generally deliver low power and sometimes aren't sufficiently reliable when used for long periods. The high rpm required for the application described herein wouldn't therefore allow them to be constantly used.

The possibility to time the operation of these motors according to the need to restore a given pressure inside the bearing structure makes it possible to run them for very short periods and therefore to increase their reliability and durability.

The following is a preferred example among many of a practical embodiment of the device, whose description refers to the attached drawings, wherein:

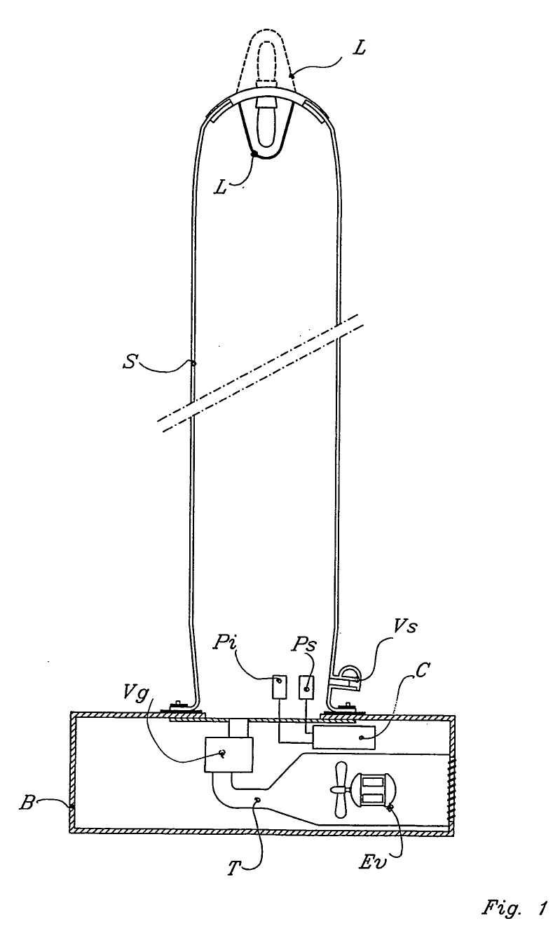

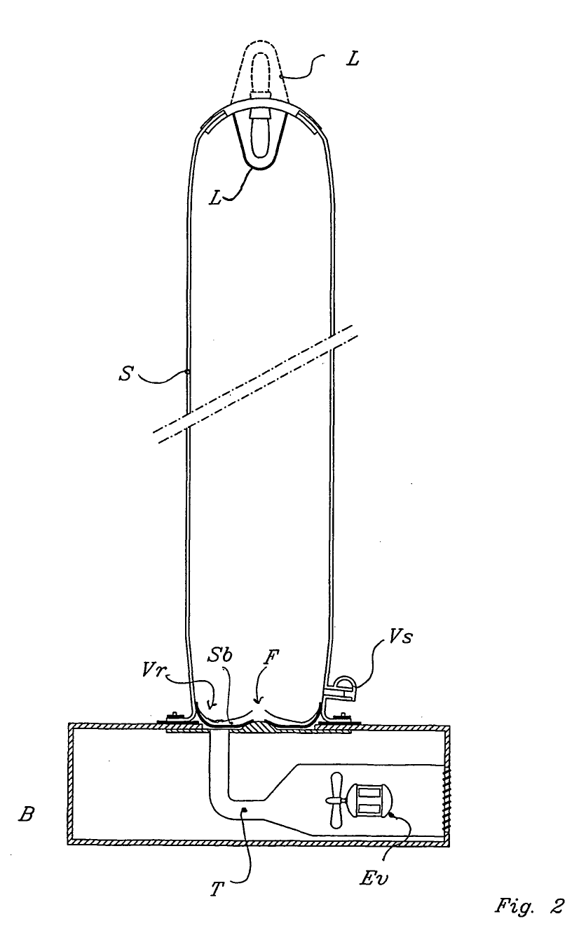

FIG. 1 shows a cross section of the device, where (B) indicates the base-container, on top of which an inflatable structure (S) is provided, which supports one or more inner or outer lamps (L). The base (B) contains an electric fan or a compressor (Ev) for inflating the structure through the pipes (T) and the solenoid valve or diaphragm valve (Vg) of the structure (S). Two pressure switches (Pi) and (Ps) positioned inside the bearing structure signal the maximum and minimum allowable value of the pressure inside the structure. A central unit (C) manages the system described above and a valve (Vs) allows the bearing structure (S) to be inflated either manually or with the mouth and to be deflated. FIG. 2 shows a cross section of the device which uses, with the function of a non-return valve (Vr), the flexible movement of the cylinder base section (Sb) at the center of which the hole (F) is provided. The air flow generated with the compressor or the electric fan (Ev) gets into the cylinder through the pipe (T). The dynamic pressure of the air causes the base section (Sb) to be lifted and the passage of air into the cylinder through the hole (F). The interruption of the air flow causes the base section (Sb) to be lowered, while the support plane of the base (B) of the bearing structure closes the hole (F).

1. Lighting system comprising an inflatable bearing structure made of fabric and/or plastic material and provided with one or more light sources and a support base at its bottom, characterized in that said bearing structure comprises an airtight air tube supporting the lighting body and wherein inflating devices keep the pressure constant.

2. Lighting system according to claim 1, characterized in that the bearing structure can be inflated electrically using fans, manually using a manual pump, or with the mouth, and in that it is provided with a solenoid valve or a unidirectional valve that allows the air to get into the bearing structure and the pressure inside the inflated structure to be kept constant.

3. Lighting system according to claims 1, 2, characterized in that the bearing structure is provided, at its base, with a free hole with O-rings that closes it when it rests on the base surface.

4. Lighting system according to claims from 1 to 3, characterized in that it is provided with an automatic system that operates the fans and opens the air inlet valve whenever the value of the inner pressure falls below a given minimum limit and stops the fans and closes the valve whenever the pressure reaches the maximum value allowed.

5. Lighting system according to claims from 1 to 4, characterized in that it is provided with one or more solenoid valves or diaphragm valves connected to the fan/fans, which open during the air inlet phase and close when the pressure inside the bearing structure has reached the desired value.

6. Lighting system according to claims from 1 to 5, characterized in that the air inlet starting or stopping mechanism is controlled by a set of sensors positioned inside the bearing structure to record the pressure minimum and maximum values and by a logic circuit that gives or denies consent for the operation of the fans and of the valve itself.

7. Lighting system according to claims from 1 to 6, characterized in that the bearing structure can be produced by combining two surfaces: an inner one suitable for ensuring airtightness and an outer one suitable for ensuring mechanical resistance.

8. Lighting system according to claims from 1 to 7, characterized in that the fans and the valves are connected to timers that authorize their start and determine their operating times.

9. Lighting system according to claims from 1 to 8, characterized in that the fans and the valves are connected to timers that can be set directly by the operator according to the needs.

10. Lighting system according to claims from 1 to 9, characterized in that it can be powered either with the mains current and with low-voltage direct current.

11. Lighting system according to claims from 1 to 10, characterized in that the motor that operates the fans and the light source are powered with direct current and in that it is provided with a transformer for connection to the electricity mains.

12. Lighting system according to claim 11, characterized in that the light source can be positioned inside or outside the bearing structure, at its top or at its base.

13. Lighting system according to claims from 1 to 12, characterized in that the light source is positioned at the base of the bearing structure and the light beam is projected towards the top of the structure through parabolic elements and/or lenses, against a reflecting surface.

14. Lighting system according to claims from 1 to 13, characterized in that the bearing structure is provided with a reflecting surface at its top.

15. Lighting system according to claims from 1 to 14, characterized in that if the light source is positioned outside the bearing structure the base and the top of the bearing structure itself are constituted by a disc in transparent material, which allows the light to penetrate inside the bearing structure.

16. Lighting system according to claims from 1 to 15, characterized in that the inner surface of the bearing structure is provided with a substance that reflects light, thus ensuring the uniform lighting of the bearing structure.
